(19) United States
(12) Patent Application Publication
(10) Pub. No.: US 2019/0160785 A1
(43) Pub. Date: May 30, 2019

(54) RESIN COMPOSITION FOR FILM, FILM, FILM WITH BASE MATERIAL, METAL/RESIN LAMINATE BODY, RESIN CURED PRODUCT, SEMICONDUCTOR DEVICE, AND METHOD FOR PRODUCING FILM

(71) Applicant: NAMICS CORPORATION, Niigata (JP)

(72) Inventors: Fumikazu KOMATSU, Niigata (JP); Issei AOKI, Niigata (JP); Junya SATO, Niigata (JP); Hiroshi TAKASUGI, Niigata (JP); Shin TERAKI, Niigata (JP)

(73) Assignee: NAMICS CORPORATION, Niigata (JP)

(21) Appl. No.: 16/312,054

(22) PCT Filed: Jun. 26, 2017
(86) PCT No.: PCT/JP2017/023454

§ 371 Date: Dec. 20, 2018

(30) Foreign Application Priority Data
Jul. 5, 2016 (JP) 2016-133027

(51) Int. Cl. B32B 15/092; B32B 27/20; B32B 27/26; C08J 5/18; C08K 3/22; C08K 3/38

(52) U.S. Cl. CPC B32B 15/092; B32B 27/20; B32B 27/26; C08K 2003/382; C08K 3/22; C08K 3/38; C08J 5/18

(57) ABSTRACT

Provided is a resin composition for a film, which is used for producing the film having excellent insulating properties and thermal conductivity. The provided resin composition for the film contains a thermosetting resin (A) and hexagonal boron nitride secondary agglomerated particles (B). Here, the hexagonal boron nitride secondary agglomerated particles (B) contains hexagonal boron nitride secondary agglomerated particles (B-1) having a cohesive breaking strength of 7 MPa or more and hexagonal boron nitride secondary agglomerated particles (B-2) having a cohesive breaking strength of 3 MPa or more and less than 7 MPa.

### TECHNICAL FIELD

The present invention relates to a resin composition for a film, the film, the film with a base material, a metal/resin laminate body, a resin cured product, a semiconductor device, and a method for producing the film.

### BACKGROUND ART

In recent years, miniaturization and higher output of electronic components, electric components and the like are progressing. A heat dissipation design thereof is one of major technical problems. In particular, it is a major problem to increase thermal conductivity of an insulating layer having a low thermal conductivity. As a technique for increasing the thermal conductivity of the insulating layer, it is generally known to add an insulating inorganic filler material into a resin forming the insulating layer. For example, metal oxides such as alumina and metal nitrides such as aluminum nitride are generally used as the inorganic filler material. Primary particles of boron nitride generally have a scaly shape. Therefore, the primary particles of boron nitride have high thermal conductivity in a planar direction. Therefore, it is known that secondary particles are formed by agglomerating scaly primary particles in order to efficiently derive high thermal conductivity in the planar direction. By using the secondary particles, higher thermal conductivity can be obtained as compared with the case of using scaly primary particles (JP-A-2010-157563, WO 2013/145961 A, and the like).

A resin composition containing a resin material forming the insulating layer, and the insulating inorganic filler material is used in order to form the insulating layer. However, the film produced using the resin composition may be used in some cases in view of good handling properties.

### SUMMARY OF THE INVENTION

### Problems to be Solved by the Invention

From the viewpoint of thermal conductivity, it has been considered preferable to add the secondary particles of boron nitride as the insulating filler material to the resin composition for the film. However, it has been apparent that the insulating layer made of the film produced using the resin composition fails to obtain the intended thermal conductivity in some cases.

An object of the present disclosure is to provide the resin composition for the film used for producing the film having excellent insulating properties and thermal conductivity in order to solve the problems in the above-described typical techniques.

### Solution to the Problems

The present inventors have extensively studied to achieve the above object. As a result, it has been apparent that since the secondary particles of boron nitride tend to collapse, the secondary particles collapse when uniformly dispersed in the resin composition for the film, and thus the thermal conductivity of the film produced using the resin composition may be lowered in some cases. On the other hand, it has been apparent that when a breaking strength of the secondary particles is too high, the film is not sufficiently compressed even if the produced film is press-cured, and thus a cured material having high thermal conductivity may not be obtained in some cases.

The present disclosure provides a resin composition for a film, based on the above knowledge, including a thermosetting resin (A); and hexagonal boron nitride secondary agglomerated particles (B), wherein the hexagonal boron nitride secondary agglomerated particles (B) includes: hexagonal boron nitride secondary agglomerated particles (B-1) having a cohesive breaking strength of 7 MPa or more; and hexagonal boron nitride secondary agglomerated particles (B-2) having a cohesive breaking strength of 3 MPa or more and less than 7 MPa.

In a resin composition for a film of the present embodiment, a mixing ratio (mass ratio) ((B-1)/(B-2)) of the hexagonal boron nitride secondary agglomerated particles (B-1) to the hexagonal boron nitride secondary agglomerated particles (B-2) is preferably 10 to 0.05.

The resin composition for the film of the present embodiment may contain alumina particles (C). In the resin composition for the film of the present embodiment, a mixing ratio (mass ratio) ((C)/(B)) of the alumina particles (C) to the hexagonal boron nitride secondary agglomerated particles (B) is preferably 1 or less.

The resin composition for the film of the present embodiment preferably contains a curing agent (D).

The present disclosure provides a film formed from the resin composition for the film of the present embodiment.

The present disclosure provides a film with a base material, having a layer made of the resin composition for the film of the present embodiment, which is formed on at least one surface of a plastic base material.

The present disclosure provides a metal/resin laminate body, having a layer made of the resin composition for the film of the present embodiment, which is formed on at least one surface of a metal plate or a metal foil.

The present disclosure provides a resin cured product obtained by curing the resin composition for the film of the present embodiment.

The present disclosure provides a semiconductor device using the resin composition for the film of the present embodiment.

The present disclosure provides a method for producing a film, including forming a film by applying the resin composition for the film of the present embodiment to at least one surface of the plastic base material, the metal plate and the metal foil.

### Effects of the Invention

According to the resin composition for the film of the present embodiment, it is possible to form a film having excellent insulating properties and thermal conductivity. This film having excellent insulating properties and thermal conductivity is suitably used as an interlayer adhesive for the semiconductor device and the like.

### DESCRIPTION OF THE EMBODIMENTS

The present embodiment will be described in detail below. A resin composition for a film of the present embodiment includes a thermosetting resin (A) and hexagonal boron nitride secondary agglomerated particles (B). Each component of the resin composition for the film of the present embodiment will be described below.

### (A) Thermosetting Resin

The thermosetting resin of a component (A) is not particularly limited. However, a curing temperature thereof is preferably 80° C. or more and 250° C. or less, and more preferably 130° C. or more and 200° C. or less. When the curing temperature is 250° C. or more, problems may occur such that a bonding member is deformed and the resin in the film flows out and fails to obtain sufficient adhesiveness. On the other hand, when the curing temperature is lower than 80° C., curing reaction proceeds in a step of applying the film and a step of drying the film. Therefore, there is a possibility that sufficient adhesiveness cannot be obtained when adhering the member.

The thermosetting resin of the component (A) is a compound having one or more functional groups contributing to curing in a molecule. A three-dimensional network structure is formed by reaction of the functional groups by heating. Thus, the curing proceeds. Two or more functional groups are preferably contained in one molecule from the viewpoint of properties of the cured product. Examples of the thermosetting resin of the component (A) include phenolic resin, urea resin, melamine resin, alkyd resin, unsaturated polyester resin, vinyl ester resin, epoxy resin, polyurethane resin, silicone resin, and polyimide resin. The epoxy resin is preferable among them.

Examples of the epoxy resin include: bisphenol compounds such as bisphenol A, bisphenol F and biphenol, and derivatives thereof (for example, alkylene oxide adducts); diols having an alicyclic structure such as hydrogenated bisphenol A, hydrogenated bisphenol F, hydrogenated biphenol, cyclohexanediol, cyclohexanedimethanol and cyclohexanediethanol, and derivatives thereof; aliphatic diols such as butanediol, hexanediol, octanediol, nonanediol and decanediol, and derivatives thereof; polyfunctional epoxy resins having two or more glycidyl groups obtained by epoxidizing fluorene, a fluorene derivative or the like; polyfunctional epoxy resins having a trihydroxyphenylmethane skeleton or an aminophenol skeleton and having two or more glycidyl groups; and polyfunctional epoxy resins obtained by epoxidizing a phenol novolak resin, a cresol novolak resin, a phenol aralkyl resin, a biphenyl aralkyl resin, a naphthol aralkyl resin or the like. However, the epoxy resin used in the present embodiment is not limited to these examples. The epoxy resin having a fluorene skeleton is preferable from the viewpoint of high Tg. Further, the epoxy resin having an aminophenol skeleton is preferable from the viewpoint of heat resistance

The epoxy resin may be a solid resin at room temperature or may be a liquid resin at room temperature. Both of them can be used in combination. However, the epoxy resin containing the liquid resin at room temperature is preferable from the viewpoint of film forming property.

The thermosetting resin of the component (A) preferably contains a polymer component such as a phenoxy resin. An inclusion of the polymer component provides advantages such as stabilization of an uncured film shape and ease of handling of the film during film formation and before curing. When the phenoxy resin is used as the thermosetting resin of the component (A), various phenoxy resins such as bisphenol A type phenoxy resin, bisphenol F type phenoxy resin, and bisphenol A bisphenol-F copolymerized phenoxy resin can be used. When the phenoxy resin is used as the thermosetting resin of the component (A), a weight average molecular weight (Mw) of the phenoxy resin is preferably 10,000 to 200,000.

When the epoxy resin and the phenoxy resin are used in combination as the thermosetting resin of the component (A), a mixing ratio (mass of epoxy resin)/(mass of phenoxy resin) of both is preferably 0.01 to 50, more preferably 0.1 to 10, and still more preferably 0.2 to 5.

### (B) Hexagonal Boron Nitride Secondary Agglomerated Particles

The hexagonal boron nitride secondary agglomerated particles are added for the purpose of enhancing thermal conductivity of the film produced using the resin composition for the film.

In the resin composition for the film of the present embodiment, as the hexagonal boron nitride secondary agglomerated particles of a component (B), two types of particles having different cohesive breaking strengths, specifically, hexagonal boron nitride secondary agglomerated particles (B-1) having a cohesive breaking strength of 7 MPa or more and hexagonal boron nitride secondary agglomerated particles (B-2) having a cohesive breaking strength of 3 MPa or more and less than 7 MPa are used in combination. As shown in Examples described later, when only the hexagonal boron nitride secondary agglomerated particles having a cohesive breaking strength of 7 MPa or more are used, the secondary agglomerated particles are less likely to collapse when the resin composition for the film is hot-pressed. Therefore, since the film is not sufficiently compressed, a predetermined thermal conductivity cannot be obtained. On the other hand, when only the hexagonal boron nitride secondary agglomerated particles having a cohesive breaking strength of less than 7 MPa are used, a part of the secondary agglomerated particles collapses in the process of preparing coating solution such as mixing and dispersion. Therefore, also in this case, the predetermined thermal conductivity cannot be obtained.

In contrast, in the resin composition for the film of the present embodiment, the hexagonal boron nitride secondary agglomerated particles (B-1) having a cohesive breaking strength of 7 MPa or more and the hexagonal boron nitride secondary agglomerated particles (B-2) having a cohesive breaking strength of 3 MPa or more and less than 7 MPa are used in combination. Thus, even when a part of the secondary agglomerated particles (B-2) having a cohesive breaking strength of 3 MPa or more and less than 7 MPa collapses in the process of preparing the coating solution such as mixing and dispersion, since the secondary agglomerated particles (B-1) having a cohesive breaking strength of 7 MPa or more are less likely to collapse, a sufficient amount of agglomerated particles are present in the resin composition for the film. In addition, when the resin composition is hot-pressed, since the secondary agglomerated particles (B-2) having a cohesive breaking strength of 3 MPa or more and less than 7 MPa are present in the film, the film is easily compressed. Therefore, the predetermined thermal conductivity can be obtained. Incidentally, as shown in Examples described later, when the hexagonal boron nitride secondary agglomerated particles having a cohesive breaking strength of 7 MPa or more and hexagonal boron nitride secondary agglomerated particles having a cohesive breaking strength of less than 3 MPa are used in combination, the secondary agglomerated particles having a cohesive breaking strength of less than 3 MPa collapse in the process of preparing the coating solution such as mixing and dispersion. Therefore, also in this case, the predetermined thermal conductivity cannot be obtained.

In the resin composition for the film of the present embodiment, a mixing ratio (mass ratio) ((B-1)/(B-2)) of the hexagonal boron nitride secondary agglomerated particles (B-1) to the hexagonal boron nitride secondary agglomerated particles (B-2) is preferably 10 to 0.05. When the mixing ratio (mass ratio) ((B-1)/(B-2)) of both is greater than 10, the film is not sufficiently compressed when the resin composition for the film is hot-pressed. Therefore, the predetermined thermal conductivity may not be obtained. When the mixing ratio (mass ratio) ((B-1)/(B-2)) of both is smaller than 0.05, a part of the secondary agglomerated particles (B-2) having a cohesive breaking strength of 3 MPa or more and less than 7 MPa, which occupy a large part of the particles of the component (B), collapses in the process of preparing the coating solution such as mixing and dispersion. Therefore, the predetermined thermal conductivity may not be obtained. The mixing ratio (mass ratio) ((B-1)/(B-2)) of both is more preferably 1 to 0.1, and still more preferably 0.7 to 0.2.

The resin composition for the film of the present embodiment preferably contains the hexagonal boron nitride secondary agglomerated particles of the component (B) in an amount of 40 to 80 mass % based on the total mass of all components of the resin composition for the film. When this content is less than 40 mass %, since an amount of thermally conductive filler in the film is insufficient, the predetermined thermal conductivity may not be obtained after hot-pressing. When the content exceeds 80 mass %, the film produced using the resin composition for the film is brittle. Therefore, it is difficult to maintain a shape of the film. Therefore, handling of the film is difficult. The content of the hexagonal boron nitride secondary agglomerated particles of the component (B) is more preferably 45 to 70 mass %, and still more preferably 50 to 60 mass %.

### (C) Alumina Particles

The resin composition for the film of the present embodiment may further contain alumina particles (C). The film produced using the resin composition for the film has a large specific gravity by the alumina particles added as a component (C). This improves not only the thermal conductivity but also the film forming property. As a result, a dielectric breakdown voltage is also improved. When the resin composition for the film of the present embodiment contains the alumina particles as the component (C), a mixing ratio (mass ratio) ((C)/(B)) of the component (C) to the hexagonal boron nitride secondary agglomerated particles of the component (B) is preferably 1 or less. When the mixing ratio (mass ratio) ((C)/(B)) of the alumina particles of the component (C) to the component (B) exceeds 1, problems such as failure to obtain the predetermined thermal conductivity may occur. The mixing ratio (mass ratio) ((C)/(B)) is more preferably 0.6 or less, and still more preferably 0.1 to 0.4.

When the alumina particles are contained as the component (C), a particle size thereof is not particularly limited. However, the alumina particles having a particle size smaller than a film thickness of the film produced using the resin composition for the film are preferably used. When the particle size of the alumina particles of the component (C) is greater than the film thickness of the film produced using the resin composition for the film, problems may occur such that the dielectric breakdown voltage of the film produced using the resin composition for the film is reduced. The alumina particles of the component (C) more preferably have a particle size of not more than half of the film thickness of the film produced using the resin composition for the film. Shape of the alumina particles of the component (C) is not particularly limited. The alumina particles having a properly selected shape such as a spherical shape, a round shape, a plate shape, and a fibrous shape can be used.

The resin composition for the film of the present embodiment may further contain the following components as optional components.

### (D) Curing Agent

The resin composition for the film of the present embodiment may contain a component (D) as a curing agent for the thermosetting resin of the component (A). When the thermosetting resin of the component (A) is the epoxy resin, examples of the component (D) as the curing agent which can be used include a phenol-based curing agent, an amine-based curing agent, an imidazole-based curing agent, and an acid anhydride-based curing agent. Among them, the imidazole-based curing agent is preferable from the viewpoint of curability and adhesiveness for the epoxy resin.

### (Other Components)

In the resin composition for the film of the present embodiment, for the purpose of adjusting a dielectric constant, a linear expansion coefficient, fluidity of the resin, flame retardancy and the like, the hexagonal boron nitride secondary agglomerated particles (B), and an inorganic filler other than the alumina particles of the component (C), for example, silicon oxide, magnesium oxide, zinc oxide, magnesium hydroxide, aluminum nitride, silicon nitride, diamond, silicon carbide or the like can be added. In addition, it is also possible to add a silane compound for the purpose of adjusting an adhesive force, uniform dispersion of an inorganic additive, or the like, or a dispersing agent for the purpose of preventing precipitation of the coating solution, or the like, or a rheology control agent.

The resin composition for the film of the present embodiment is obtained by dissolving or dispersing raw materials containing the components (A) and (B), and the components (C), (D) and other components, which are added as necessary, in an organic solvent. Methods such as dissolution or dispersion of these raw materials are not particularly limited. However, it is preferred that the raw materials are stirred at low speed with a planetary mixer or the like, and then dispersed by a thin tube type wet dispersing apparatus or the like. When the raw materials are dispersed using a bead mill or a ball mill, the predetermined thermal conductivity may not be obtained due to collapse of the secondary agglomerated particles.

The film of the present embodiment is formed using the above-mentioned resin composition for the film. Specifically, after the resin composition for the film is applied to at least one surface of a desired support, the film is formed by being dried. A material of the support is not particularly limited. Examples of such materials include: metal plates and metal foils such as copper and aluminum; and plastic base materials such as polyester resin, polyethylene resin, polyethylene terephthalate resin; and the like. These supports may be release-treated with a silicone-based compound or the like. Note that a film with a base material of the present embodiment can be obtained by forming a layer made of the resin composition of the present embodiment on at least one surface of the plastic base material. On the other hand, a metal/resin laminate body of the present embodiment is obtained by forming the layer made of the resin composition of the present embodiment on at least one surface of the metal plate or the metal foil.

A method for applying the resin composition for the film on the support is not particularly limited. However, a microgravure method, a slot die method, or a doctor blade method is preferable from the viewpoint of thinning of the film and film thickness control. The film having a thickness of, for example, 5 to 500 μm can be obtained by the slot die method.

Drying conditions can be appropriately set depending on the kind and amount of the organic solvent used in the resin composition for the film, a thickness of coating and the like. For example, it can be dried at 50 to 120° C. for about 1 to 30 minutes. The film thus obtained has good storage stability. Note that the film can be peeled from the support at a desired timing.

The film obtained by the above procedure can be thermally cured at a temperature of, for example, 80° C. or more and 250° C. or less, preferably 130° C. or more and 200° C. or less for 30 to 180 minutes.

The thickness of the film obtained by the above procedure is preferably 5 μm or more and 500 μm or less. When the thickness of the film is less than 5 μm, there is a possibility that required film characteristics such as insulating properties cannot be obtained. When the thickness exceeds 500 μm, the thermal conductivity of the film is reduced. Therefore, when the film is used for interlayer adhesion of a semiconductor device or the like, there is a possibility that heat dissipation of the semiconductor device or the like is reduced. The thickness of the film is more preferably 10 μm or more and 400 μm or less, and still more preferably 50 μm or more and 300 μm or less.

The film of the present embodiment has excellent thermal conductivity after curing. Specifically, the film of the present embodiment preferably has a thermal conductivity of 9 W/m·K or more after curing. When the thermal conductivity is less than 9 W/m·K, there is a possibility that the heat dissipation of the semiconductor device or the like is reduced when the film is used for interlayer adhesion of the semiconductor device or the like. The film of the present embodiment more preferably has a thermal conductivity of 11 W/m·K or more after curing.

The film of the present embodiment has excellent insulating properties after curing. Specifically, the film of the present embodiment preferably has a dielectric breakdown voltage of 5 kV/100 μm or more after curing. When the dielectric breakdown voltage is less than 5 kV/100 μm, insulating properties required for the semiconductor device or the like may not be satisfied. The film of the present embodiment more preferably has a dielectric breakdown voltage of 7 kV/100 μm or more after curing.

The resin composition for the film of the present embodiment is used for the interlayer adhesion between constituent elements of the semiconductor device of the present embodiment. Specifically, for example, the resin composition for the film of the present embodiment is used for the interlayer adhesion between a substrate and a heat sink, the interlayer adhesion between an electronic component and the substrate, the insulating layer covering the electronic component, or the like. Or, in a device including the electronic component, the film formed from the resin composition for the film of the present embodiment, the film with the base material formed with a layer made of the resin composition for the film, or the metal/resin laminate body formed with the layer made of the resin composition for the film is used.

### EXAMPLES

The present embodiment will be described in detail below with reference to Examples. However, the present embodiment is not limited to these.

### Examples 1 to 9, Comparative Examples 1 to 3

With compositions shown in Table 1, the thermosetting resin of component (A), other additives, and methyl ethyl ketone as the organic solvent were charged into the planetary mixer and stirred for 30 minutes. Thereafter, the hexagonal boron nitride secondary agglomerated particles of the component (B) and the alumina particles of the component (C) were added and stirred for 1 hour. Further, the curing agent of the component (D) was added and stirred for 10 minutes. The resulting mixture was dispersed in a wet atomizing apparatus (MN2-2000AR manufactured by Yoshida Kikai Co., Ltd.), whereby the coating solution containing the resin composition was obtained. The coating solution containing the resulting resin composition was applied to one surface of the plastic base material (PET film subjected to release treatment), whereby the film having a thickness of about 100 μm was produced.

The components used in preparing the resin composition for the film are as follows.

### Component (A): Thermosetting Resin

(A-1): liquid epoxy resin, product name 630, manufactured by Mitsubishi Chemical Corporation
(A-2): solid epoxy resin, product name CG-500, manufactured by Osaka Gas Chemicals Co., Ltd.
(A-3): phenoxy resin, product name YX7200, manufactured by Mitsubishi Chemical Corporation

### Component (B): Hexagonal Boron Nitride Secondary Agglomerated Particles

(B-1a): product name FP-40 (ultra-high strength product), manufactured by Denka Co., Ltd., cohesive breaking strength 8.2 MPa
(B-1b): product name FP-70 (ultra-high strength product), manufactured by Denka Co., Ltd., cohesive breaking strength 7.7 MPa
(B-2): product name HP-40MF100, manufactured by Mizushima Ferroalloy Co., Ltd., cohesive breaking strength 4.8 MPa
(B′): product name FP-40 (normal strength product), manufactured by Denka Co., Ltd., cohesive breaking strength 1.3 MPa

The cohesive breaking strength of the hexagonal boron nitride secondary agglomerated particles of the component (B) was measured by the following method.

For the measurement, a micro compression tester (product name MCT-510, manufactured by Shimadzu Corporation) was used. In the process of increasing a compressive force at a load rate of 0.8924 mN/sec, it was determined that a point where a displacement greatly changed was a test force in which an agglomerate was broken. The cohesive breaking strength of the particles was calculated from the test force and the particle size by the following formula.

Cs (Pa)=2.48×P/πdr²

Cs: cohesive breaking strength (Pa)
P: test force at breaking point (N)
d: measured diameter of measured particle (mm)

### Component (D): Curing Agent

The cohesive breaking strength of each variety was determined by measuring the cohesive breaking strength of ten samples randomly extracted from the hexagonal boron nitride secondary agglomerated particles of the same variety. An average value of these ten measurement values was determined as the cohesive breaking strength of the variety.

### Component (C): Alumina Particles

(C-1): product name DAW0735, manufactured by Denka Co., Ltd. (average particle size 7 μm)

### Component (D): Curing Agent

(D-1) product name EH-2021, imidazole-based curing agent, manufactured by Shikoku Chemicals Corporation
(D-2) product name 2PHZPW, imidazole-based curing agent, manufactured by Shikoku Chemicals Corporation

### Component (E): Other Components

(E-1) dispersing agent, product name ED216, Kusumoto Chemicals, Ltd.
(E-2) silane coupling agent, product name KBM403, manufactured by Shin-Etsu Chemical Co., Ltd.
(E-3): rheology control agent, product name BYK-410, manufactured by BYK Japan KK

Evaluation of the coating solution and the film with the base material prepared and produced by the above procedure was performed by the following method.

### <Evaluation of Film Forming Property>

Using the coating solution prepared by the above procedure, a film was formed at a line speed of 0.5 m/min by a knife coater. A state of the uncured film obtained by drying at 90° C. for 10 minutes was observed. Results were evaluated according to the following criteria.

B: film can be cleanly formed
C: film can be formed, but somewhat brittle and requires careful handling
D: film cannot be formed

### <Method for Measuring Thermal Conductivity>

The film was laminated so as to have a thickness of 300 to 600 μm. A cured film was produced by vacuum pressing at 180° C. for 1 hour (a pressure at the time of press hardening was 5 to 10 MPa). A specific gravity of the film was measured by the Archimedes method. After the cured film was cut into 10 mm squares, thermal diffusivity was measured using a thermal conductivity measuring apparatus (manufactured by NETZSCH Japan K.K.). Further, using a specific heat separately obtained, the thermal conductivity was obtained by the following formula.

Thermal conductivity (W/m·K)=(thermal diffusivity)×(specific heat)×(specific gravity)

The obtained results were evaluated according to the following criteria.

A: 11 (W/m·K) or more
B: 9 (W/m·K) or more
D: less than 9 (W/m·K)

### <Method for Measuring Dielectric Breakdown Voltage>

The cured film was produced by vacuum pressing the film at 180° C. for 1 hour (the pressure at the time of press hardening was 5 to 10 MPa). For the measurement, a dielectric breakdown voltage measuring apparatus (product name: DAC-WT-50, manufactured by Soken Electric Co., Ltd.) was used. In the process of applying a voltage at 200 V/s between electrodes sandwiching the cured film, the voltage when the insulating layer was broken was measured. Measurement was performed five times. An average value of the obtained measured values was determined as the dielectric breakdown voltage of the composition.

The obtained results were evaluated according to the following criteria.

A: 7 (kV/100 μm) or more
B: 5 (kV/100 μm) or more and less than 7 (kV/100 μm)
D: less than 5 (kV/100 um)

The results are shown in the following table.

TABLE 1

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| (A-1) | 10.7 | 10.7 | 10.7 | 11.8 | 7.9 | 7.1 |
| (A-2) | 5.3 | 5.3 | 5.3 | 5.3 | 4.0 | 6.0 |
| (A-3) | 10.7 | 10.7 | 10.7 | 11.8 | 7.9 | 7.1 |
| (B-1a) | 17.4 | 34.9 | 52.2 | | 18.4 | 28.3 |
| (B-1b) | | | | 17.4 | | |
| (B-2) | 52.2 | 34.9 | 17.4 | 52.2 | 58.1 | 28.3 |
| (B′) | | | | | | |
| (C-1) | 0 | 0 | 0 | 0 | 0 | 19.2 |
| (D-1) | 1.3 | 1.3 | 1.3 | 1.4 | 1.0 | 1.0 |
| (D-2) | | | | | | |
| (E-1) | | | | | | |
| (E-2) | 2.0 | 2.0 | 2.0 | | 1.5 | 2.8 |
| (E-3) | 0.3 | 0.3 | 0.3 | | 0.2 | 0.2 |
| Film forming | B | C | C | B | C | C |
| property | | | | | | |
| Thermal | B(9.0) | B(9.3) | B(10.1) | B(9.7) | A(14.2) | A(13.0) |
| conductivity | | | | | | |
| (W/m · K) | | | | | | |
| Withstand | A(9.4) | B(6.8) | B(5.0) | A(8.1) | B(5.1) | B(6.4) |
| voltage | | | | | | |
| (kV/100 μm) | | | | | | |

TABLE 2

| | | | | Com- | Com- | Com- |
|---|---|---|---|---|---|---|
| | | | | parative | parative | parative |
| | Exam- | Exam- | Exam- | Exam- | Exam- | Exam- |
| | ple 7 | ple 8 | ple 9 | ple 1 | ple 2 | ple 3 |
| (A-1) | 7.1 | 7.1 | 7.1 | 10.7 | 10.7 | 10.7 |
| (A-2) | 6.0 | 6.0 | 6.0 | 5.3 | 5.3 | 5.3 |
| (A-3) | 7.1 | 7.1 | 7.1 | 10.7 | 10.7 | 10.7 |
| (B-1a) | 21.2 | 7.1 | 18.4 | 69.7 | | 34.9 |
| (B-1b) | | | | | | |
| (B-2) | 35.3 | 49.5 | 30.7 | | 69.7 | |
| (B′) | | | | | | 34.9 |
| (C-1) | 19.2 | 19.2 | 26.7 | 0 | 0 | 0 |
| (D-1) | 1.0 | 1.0 | | 1.3 | 1.3 | 1.3 |
| (D-2) | | | 1.0 | | | |
| (E-1) | | | 2.8 | | | |
| (E-2) | 2.8 | 2.8 | | 2.0 | 2.0 | 2.0 |
| (E-3) | 0.2 | 0.2 | 0.2 | 0.3 | 0.3 | 0.3 |
| Film forming | B | B | B | C | B | B |
| property | | | | | | |
| Thermal | A(13.2) | A(11.3) | B(9.2) | D(8.1) | D(7.8) | D(7.8) |
| conductivity | | | | | | |
| (W/m · K) | | | | | | |
| Withstand | A(7.3) | A(8.4) | B(6.6) | B(5.9) | B(5.2) | B(5.3) |
| voltage | | | | | | |
| (kV/100 μm) | | | | | | |

All of Examples 1 to 9 show the film forming property of C or better. Further, all of these Examples show the thermal conductivity and the withstand voltage of B or better. In Examples 2, 3, and 5, the mixing ratio of the hexagonal boron nitride secondary agglomerated particles (B-1) and (B-2) is different from that in Example 1. In Example 4, the type of the hexagonal boron nitride secondary agglomerated particles (B-1) having a cohesive breaking strength of 7 MPa or more is different from other Examples. In Examples 6 to 9, the alumina particles (C) are added unlike the other Examples. The thermal conductivity was D in all of Comparative Example 1 in which only the hexagonal boron nitride secondary agglomerated particles (B-1) were added, Comparative Example 2 in which only the hexagonal boron nitride secondary agglomerated particles (B-2) were added, and Comparative Example 3 in which the hexagonal boron nitride secondary agglomerated particles (B′) having a cohesive breaking strength of less than 3 MPa was added instead of the hexagonal boron nitride secondary agglomerated particles (B-2).

The resin composition for the film according to the embodiment of the present disclosure may be the following first to fifth resin compositions for the film.

The first resin composition for the film is the resin composition for the film containing the thermosetting resin (A) and the hexagonal boron nitride secondary agglomerated particles (B), wherein the hexagonal boron nitride secondary agglomerated particles (B) contains the hexagonal boron nitride secondary agglomerated particles (B-1) having a cohesive breaking strength of 7 MPa or more and the hexagonal boron nitride secondary agglomerated particles (B-2) having a cohesive breaking strength of 3 MPa or more and less than 7 MPa.

The second resin composition for the film is the first resin composition for the film, wherein the mixing ratio (mass ratio) ((B-1)/(B-2)) of the hexagonal boron nitride secondary agglomerated particles (B-1) to the hexagonal boron nitride secondary agglomerated particles (B-2) is 10 to 0.05.

The third resin composition for the film is the first or second resin composition for the film, further containing the alumina particles (C).

The fourth resin composition for the film is the third resin composition for the film, wherein the mixing ratio (mass ratio) ((C)/(B)) of the alumina particles (C) to the hexagonal boron nitride secondary agglomerated particles (B) is 1 or less.

The fifth resin composition for the film is any one of the first to fourth resin compositions for the film, further containing the curing agent (D).

The film according to the embodiment of the present disclosure may be the film formed from any one of the first to fifth resin compositions for the film.

The film with the base material according to the embodiment of the present disclosure may be the film with the base material, wherein a layer made of any one of the first to fifth resin compositions for the film is formed on at least one surface of the plastic base material.

The metal/resin laminate body according to the embodiment of the present disclosure may be the metal/resin laminate body, wherein a layer made of any one of the first to fifth resin compositions for the film is formed on at least one surface of the metal plate or the metal foil.

The resin cured product according to the embodiment of the present disclosure may be the resin cured product obtained by curing any one of the first to eighth resin compositions for the film.

The semiconductor device according to the embodiment of the present disclosure may be the semiconductor device using any one of the first to fifth resin compositions for the film.

A method for producing the film according to the embodiment of the present disclosure may be the method for producing the film by applying the first to fifth resin composition for the film to at least one surface of the plastic base material, the metal plate, or the metal foil.

1. A resin composition for a film, comprising:
a thermosetting resin (A); and hexagonal boron nitride secondary agglomerated particles (B), wherein
the hexagonal boron nitride secondary agglomerated particles (B) comprises:
hexagonal boron nitride secondary agglomerated particles (B-1) having a cohesive breaking strength of 7 MPa or more; and
hexagonal boron nitride secondary agglomerated particles (B-2) having a cohesive breaking strength of 3 MPa or more and less than 7 MPa.

2. The resin composition for the film according to claim 1, wherein
a mixing ratio (mass ratio) ((B-1)/(B-2)) of the hexagonal boron nitride secondary agglomerated particles (B-1) to the hexagonal boron nitride secondary agglomerated particles (B-2) is 10 to 0.05.

3. The resin composition for the film according to claim 1, further comprising alumina particles (C).

4. The resin composition for the film according to claim 3, wherein
a mixing ratio (mass ratio) ((C)/(B)) of the alumina particles (C) to the hexagonal boron nitride secondary agglomerated particles (B) is 1 or less.

5. The resin composition for the film according to claim 1, further comprising a curing agent (D).

6. A film formed from the resin composition for the film according to claim 1.

7. A film with a base material, comprising a layer made of the resin composition for the film according to claim 1, which is formed on at least one surface of a plastic base material.

8. A metal/resin laminate body, comprising a layer made of the resin composition for the film according to claim 1, which is formed on at least one surface of a metal plate or a metal foil.

9. A resin cured product obtained by curing the resin composition for the film according to claim 1.

10. A semiconductor device using the resin composition for the film according to claim 1.

11. A method for producing a film, comprising forming a film by applying the resin composition for the film according to claim 1 to at least one surface of a plastic base material, a metal plate, or a metal foil.

12. The resin composition for the film according to claim 2, further comprising alumina particles (C).

13. The resin composition for the film according to claim 12, wherein
a mixing ratio (mass ratio) ((C)/(B)) of the alumina particles (C) to the hexagonal boron nitride secondary agglomerated particles (B) is 1 or less.

14. The resin composition for the film according to claim 2, further comprising a curing agent (D).

15. The resin composition for the film according to claim 3, further comprising a curing agent (D).

16. The resin composition for the film according to claim 4, further comprising a curing agent (D).

17. A film formed from the resin composition for the film according to claim 2.

18. A film formed from the resin composition for the film according to claim 3.

19. A film formed from the resin composition for the film according to claim 4.
